(19) United States
(12) Patent Application Publication
(10) Pub. No.: US 2025/0372052 A1
(43) Pub. Date: Dec. 4, 2025

(54) DYNAMIC HALO MITIGATION IN A FULL AREA LOCAL DIMMING DISPLAY

(71) Applicant: VISTEON GLOBAL TECHNOLOGIES, INC., Van Buren Township, MI (US)

(72) Inventors: Futoshi Matsumoto, Novi, MI (US); Paul Fredrick Luther Weindorf, Novi, MI (US)

(73) Assignee: VISTEON GLOBAL TECHNOLOGIES, INC., Van Buren Township, MI (US)

(21) Appl. No.: 18/679,416

(22) Filed: May 30, 2024

(51) Int. Cl. G09G 3/34

(52) U.S. Cl. CPC G09G 3/3426; G09G 2320/0233; G09G 2320/0646; G09G 2360/144; G09G 2380/10

(57) ABSTRACT

A display system having a backlight source, a transmissive display, and an electronic control unit. The backlight source defines a full area matrix of a plurality of backlight zones, and is operational to generate a background light in response to a background signal. The transmissive display has a plurality of pixels, is mounted adjacent to the backlight source, and is operational to generate a plurality of visible images by modulating the background light in response to a video signal. The electronic control unit is coupled to the backlight source and the transmissive display, and is operational to adjust an on-pixel-ratio function that controls the background signal in response to an ambient light level present at the transmissive display. The on-pixel-ratio function dynamically darkens the background light on an individual background zone basis to reduce a leakage halo effect.

### TECHNICAL FIELD

The present disclosure generally relates to systems and methods for dynamic halo mitigation in full area local dimming displays.

### BACKGROUND

In automotive display applications, light sensors have been utilized to automatically control the display luminance as a function of an ambient lighting environment. As the ambient lightning environment changes, symbology luminance presented by the display changes to maintain a comfortable level of viewing brightness. Although automatic luminance control methods maintain clear visibility of the symbology under bright ambient conditions, small symbols in black image areas are often be accompanied by visible halos under dark ambient conditions.

Accordingly, those skilled in the art continue with research and development efforts in the field of dynamic halo mitigation in full area local dimming displays.

### SUMMARY

A display system is provided herein. The display system includes a backlight source, a transmissive display, and an electronic control unit. The backlight source defines a full area matrix of a plurality of backlight zones, and is operational to generate a background light in response to a background signal. The transmissive display has a plurality of pixels, is mounted adjacent to the backlight source, and is operational to generate a plurality of visible images by modulating the background light in response to a video signal. The electronic control unit is coupled to the backlight source and the transmissive display, and is operational to adjust an on-pixel-ratio function that controls the background signal in response to an ambient light level present at the transmissive display. The on-pixel-ratio function dynamically darkens the background light on an individual background zone basis to reduce a leakage halo effect.

In one or more embodiments of the display system, a given zone of the plurality of backlight zones is spatially aligned with at least four of the plurality of pixels of the transmissive display.

In one or more embodiments of the display system, the on-pixel-ratio function establishes an approximately linear line from approximately 1 percent of the plurality of pixels in the given zone being on to transmit the background light to approximately 100 percent of the plurality of pixels in the given zone being on to transmit the background light.

In one or more embodiments of the display system, a slope of the approximately linear line approaches zero as the ambient light level increases.

In one or more embodiments of the display system, the electronic control unit is further operational to stop the dynamic darkening of the background light at approximately 10 percent of a maximum operational daytime luminance or nighttime luminance.

In one or more embodiments, the display system includes one or more ambient light sensors operational to sense the ambient light level received along a first direction substantially toward the transmissive display. The transmissive display presents the plurality of visible images in a second direction away from the transmissive display.

In one or more embodiments of the display system, the one or more ambient light sensors are one or more instrument panel daylight sensors of a vehicle.

In one or more embodiments, the display system includes a forward looking light sensor operational to sense a forward light level received substantially along the second direction. The electronic control unit is further operational to adjust the on-pixel-ratio function and a video brightness function in response to the forward light level.

In one or more embodiments of the display system, the forward looking light sensor directly measures the forward light level entering through a front windshield of a vehicle.

A method for dynamic halo reduction is provided herein. The method includes generating a background light in response to a background signal using a backlight source that defines a full area matrix of a plurality of backlight zones; generating a plurality of visible images by modulating the background light in response to a video signal using a transmissive display with a plurality of pixels and mounted adjacent to the backlight source; and adjusting an on-pixel-ratio function in an electronic control unit that controls the background signal in response to an ambient light level present at the transmissive display. The on-pixel-ratio function dynamically darkens the background light on an individual background zone basis to reduce a leakage halo effect.

In one or more embodiments of the method, a given zone of the plurality of backlight zones is spatially aligned with at least four of the plurality of pixels of the transmissive display.

In one or more embodiments of the method, the on-pixel-ratio function establishes an approximately linear line from approximately 1 percent of the plurality of pixels in the given zone being on to transmit the background light to approximately 100 percent of the plurality of pixels in the given zone being on to transmit the background light.

In one or more embodiments of the method, a slope of the approximately linear line approaches zero as the ambient light level increases.

In one or more embodiments, the method includes stopping the dynamic darkening of the background light at approximately 10 percent of a maximum operational daytime luminance or nighttime luminance.

In one or more embodiments, the method includes sensing the ambient light level received along a first direction substantially toward the transmissive display with one or more ambient light sensors. The transmissive display presents the plurality of visible images in a second direction away from the transmissive display.

In one or more embodiments of the method, the one or more ambient light sensors are one or more instrument panel daylight sensors of a vehicle.

In one or more embodiments, the method includes sensing a forward light level received substantially along the second direction with a forward looking light sensor, and the adjusting of the on-pixel-ratio function and a video brightness function are in further response to the forward light level.

In one or more embodiments, the method includes directly measuring the forward light level entering through a front windshield of a vehicle with the forward looking light sensor.

A non-transitory computer readable medium on which is recorded instructions, executable by a processor, for control of a display is provided herein. Execution of the instructions causes the processor to generate a background signal that controls a background light in response to a background signal. The background light is generated using a backlight source that defines a full area matrix of a plurality of backlight zones. The processor further generates a video signal that controls a plurality of visible images by modulating the background light in response to a video signal. The plurality of visible images are generated using a transmissive display with a plurality of pixels and mounted adjacent to the backlight source. The processor adjusts an on-pixel-ratio function that controls the background signal in response to an ambient light level present at the transmissive display. The on-pixel-ratio function dynamically darkens the background light on an individual background zone basis to reduce a leakage halo effect.

In one or more embodiments of the non-transitory computer readable medium, the processor is further operational to stop the dynamic darkening of the background light at approximately 10 percent of a maximum operational daylight luminance or a nighttime luminance.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a context of a vehicle.

FIG. 2 illustrates a side view schematic diagram of a driver relative to a display in accordance with one or more exemplary embodiments.

FIG. 3 illustrates a perspective schematic diagram of a display in accordance with one or more exemplary embodiments.

FIG. 4 illustrates a graph of a light spread function in a single dimension across two backlight zones in accordance with one or more exemplary embodiments.

FIG. 5 illustrates a graph of an on-pixel-ratio function in accordance with one or more exemplary embodiments.

FIG. 6 illustrates an overlay of reflected background luminance values on a Burnette visibility analysis graph in accordance with one or more exemplary embodiments.

FIG. 7 illustrates a functional block diagram of an automatic display luminance system in accordance with one or more exemplary embodiments.

FIG. 8 illustrates a graph of a pupillary light reflex to a blue light stimulus in accordance with one or more exemplary embodiments.

FIG. 9 illustrates a graph of a pupil diameter response time mode in accordance with one or more exemplary embodiments.

FIG. 10 illustrates a functional block diagram for halo mitigation in accordance with one or more exemplary embodiments.

FIG. 11 illustrates a schematic diagram of an electronic control unit in accordance with one or more exemplary embodiments.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a display system suitable for use in a vehicle. The display system provides benefits for control of display symbology using full area local dimming coupled with dynamic halo mitigation. A backlight source of the display system defines multiple backlight zones. Each backlight zone is independently controllable to provide a local backlight in a range of luminance values. Each backlight zone is aligned with multiple pixels of a transmissive display. In various situations, multiple neighboring backlight zones are illuminated to provide appropriate backlighting to some pixels. While small symbols are being presented, a few of the pixels aligned with a given backlight zone are controlled to a variable on-state (e.g., a few percent on-state to 100 percent on-state) to allow transmission of the local backlight. The remaining pixels are controlled to an off state to block the local backlight. Since the off-state pixels generally leak some small amount of the local backlight, halos and similar fringe artifacts may be present in the neighborhood of the on-state pixels that form the symbols.

The leaked light is generally reduced below a visibility threshold by adjusting the local backlight based on one or more of an ambient light level at a surface of the display, a forward light level, and/or a percentage of the pixels in the “on” condition for the corresponding backlight zone. At bright ambient light levels, bright forward light levels, and/or high percentages of neighboring on-state pixels, the halos tend to be washed out so no corrective action may be taken. At dark ambient light levels, dark forward light levels, and/or high percentages of neighboring off-state pixels, the halo may be more noticeable. In such cases, an electronic control unit may reduce the local backlight levels to bring the halos below the visibility threshold. A floor local backlight level of approximately 10% maximum operational daytime luminance or nighttime luminance may be established in the electronic control unit to stop reduction of the symbology to unviewable levels. The combination provides a new product class that provides visibility of entire images under various ambient lighting conditions, while at the same time dynamically reduces the halo effects.

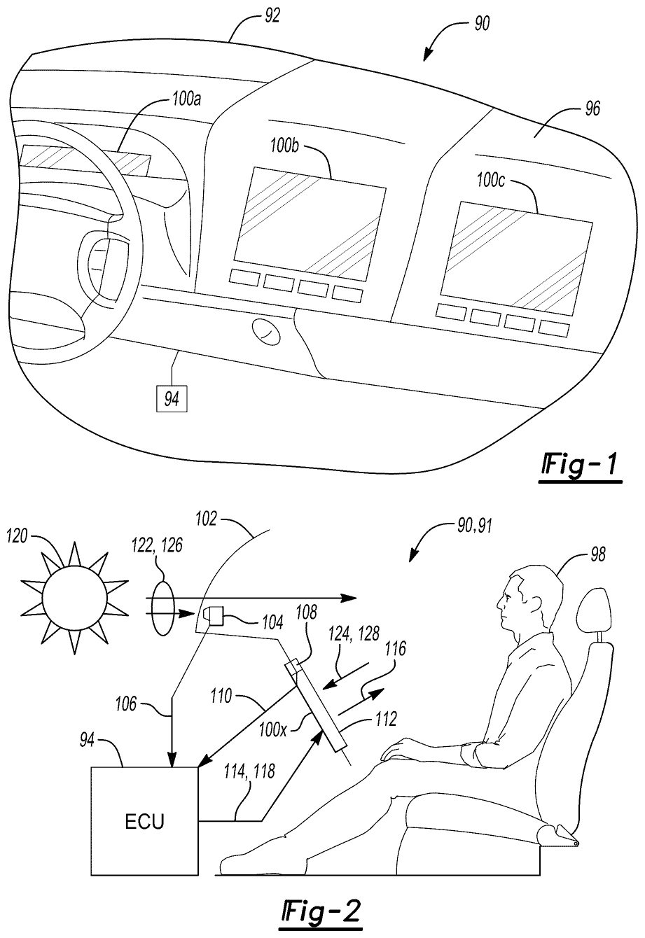

FIG. 1 illustrates a context of a vehicle 90. The vehicle 90 generally includes a body 92, an electronic control unit 94, and an instrument panel 96 having one or more displays 100a-100c. The body 92 may implement an interior body of the vehicle 90. The vehicle 90 may include mobile vehicles such as automobiles, trucks, motorcycles, boats, trains and/or aircraft. In some embodiments, the body 92 may be part of a stationary object. The stationary objects may include, but are not limited to, billboards, kiosks and/or marquees. Other types of vehicles 90 may be implemented to meet the design criteria of a particular application.

The electronic control unit 94 may implement one or more display-driver circuits. The electronic control unit 94 is generally operational to generate control signals that drive the displays 100a-100c. In various embodiments, the control signals may be configured to provide instrumentation (e.g., speed, tachometer, fuel, temperature, etc.) to at least one of the displays 100a-100c (e.g., 100a). In some embodiments, the control signals may also be configured to provide video (e.g., a rear-view camera video, a forward-view camera video, an onboard DVD player, etc.) to the displays 100a-100c. In other embodiments, the control signals may be further configured to provide alphanumeric information shown on one or more of the displays 100a-100c.

In various embodiments, the electronic control unit 94 generally comprises at least one microcontroller. The at least one microcontroller may include one or more processors, each of which may be embodied as a separate processor, an application specific integrated circuit (ASIC), a field programmable gate array (FPGA), or a dedicated electronic control unit. The at least one microcontroller may be any sort of electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present method may be stored in the memory and executed as set forth herein. The executable instructions may be a series of instructions employed to run applications on the at least one microcontroller (either in the foreground or background). The at least one microcontroller may receive commands and information, in the form of one or more input signals from various controls or components in the vehicle 90 and communicate instructions to the displays 100a-100c through one or more control signals to control the displays 100a-100c.

The instrument panel 96 implements a structure (or instrument cluster) that supports the displays 100a-100c. As illustrated, the display 100a may be a cluster display positioned for use by a driver. The display 100b may be a console display positioned for use by the driver and a passenger. The display 100c may be a passenger display positioned for use by the passenger.

The displays 100a-100c are generally mounted to the instrument panel 96. In various embodiments, one or more of the displays 100a-100c may be disposed inside the vehicle 90. In other embodiments, one or more of the displays 100a-100c may be disposed on an exterior of the vehicle 90. One or more of the displays 100a-100c may implement an enhanced vehicle display that is visible to a driver under a variety of lighting conditions. Control signals used to generate images on the displays 100a-100c may be received as electrical communications from the electronic control unit 94.

FIG. 2 illustrates a side view schematic diagram of an example driver 98 relative to a display 100x in accordance with one or more exemplary embodiments. The display 100x may be representative of the displays 100a-100c (e.g., 100a). The driver 98 is shown sitting in a driver's seat of the vehicle 90 behind the display 100a. In other embodiments, the driver 98 may be a passenger sitting in another seat and/or located behind another display 100b and/or 100c. The display 100x generally has a face 112 (or front surface) that may be seen by the driver 98. The vehicle 90 includes the electronic control unit 94, a front windshield 102, a forward looking light sensor 104, and an ambient light sensor 108. The electronic control unit 94, the display 100x, the forward looking light sensor 104 and the ambient light sensor 108 generally form a display system 91.

The forward looking light sensor 104 implements an optical sensor. The forward looking light sensor 104 is operational to sense a forward luminance level 106 received in a forward looking light 122. The forward looking light 122 may be received substantially along a second direction 126 toward the driver 98. The forward luminance level 106 is presented to the electronic control unit 94.

The ambient light sensor 108 implements another optical sensor. The ambient light sensor 108 is operational to sense an ambient luminance level 110 received in the ambient light 124. The ambient light 124 may be received along a first direction 128 substantially toward the transmissive display 100x. The ambient luminance level 110 is presented to the electronic control unit 94.

The sun 120 may present the forward looking light 122 that passes through the front windshield 102 and is received by the forward looking light sensor 104. While the driver 98 is looking up over the display 100x and out through the front windshield 102, the driver 98 also sees the forward looking light 122.

An ambient light 124 may be visible to the driver 98 from directions other than from the sun 120. The ambient light 124 may arise from reflections of the light from the sun 120, other lights around the vehicle 90 (e.g., streetlights), lights within the vehicle 90 (e.g., dome lights), other vehicle headlights, and the like. While the driver 98 is looking down at the face 112 of the display 100x and/or at the instrument panel 96, the driver 98 sees the ambient light 124 reflected from the display 100x, whereas the forward looking light 122 may be out of direct view.

The electronic control unit 94 is in electrical communication with the forward looking light sensor 104, the ambient light sensor 108, and the display 100x. The electronic control unit 94 receives the forward luminance level (or value) 106 from the forward looking light sensor 104. The forward luminance level 106 is proportional to an intensity of the forward looking light 122 sensed by the forward looking light sensor 104. The electronic control unit 94 also receives the ambient luminance level (or value) 110 from the ambient light sensor 108. The ambient luminance level 110 is proportional to an intensity of the ambient light 124 sensed by the ambient light sensor 108.

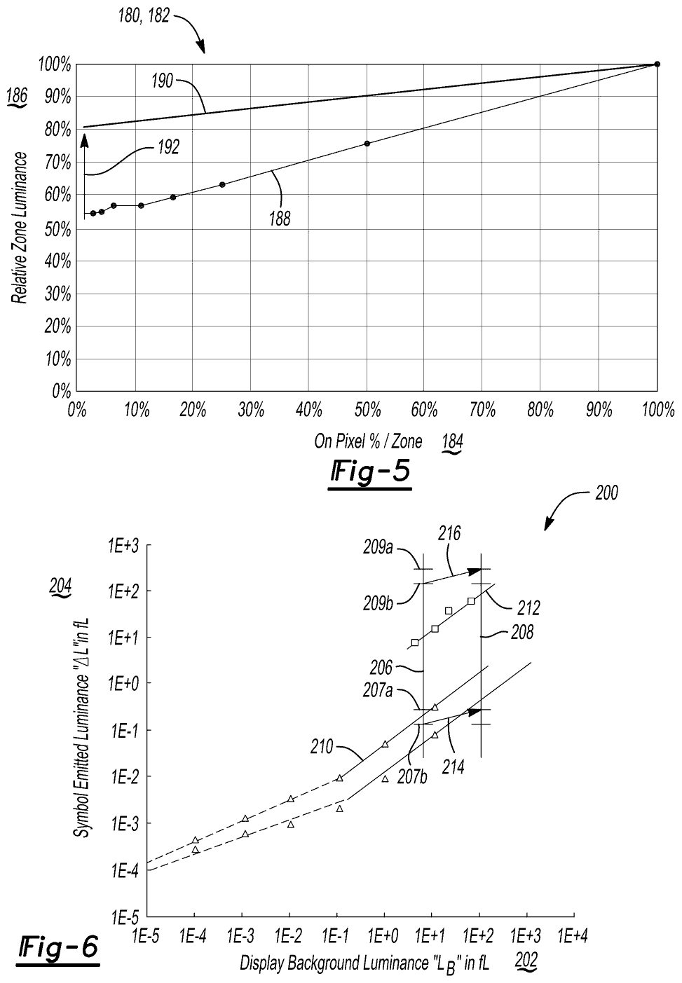

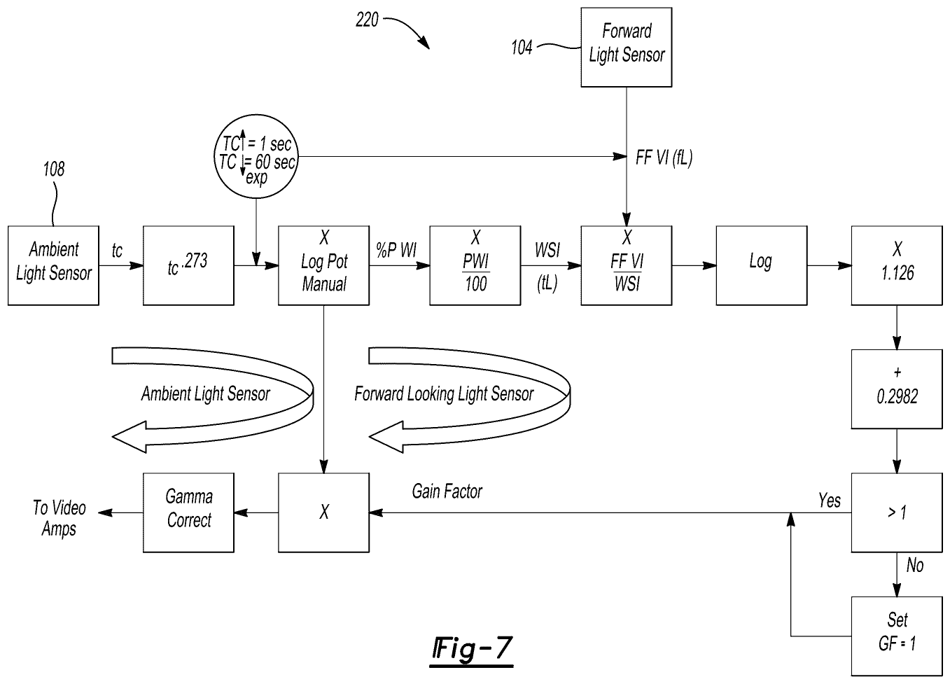

The electronic control unit 94 is operational to use the forward luminance level 106 and/or the ambient luminance level 110 to dynamically adjust a background light in the display 100x via a background signal 114, and adjust images 116 presented by the display 100x in response to patterns 130 (e.g., symbols, numbers, text, etc.) in a video signal 118. The adjustments generally lower the relative zone luminance of zones as a function of how many of the pixels in a zone are switched “on”. Under bright conditions while the pupils of the driver 98 are narrow, the electronic control unit 94 increases a zone-by-zone brightness, depending on how many pixels are switched “on” (e.g., each zone may be at a different point on line 188 in FIG. 5), on the display 100x (e.g., increases a background light source within the display) to prevent the images 116 on the display 100x from being washed out. Therefore, the driver 98 may comfortably view the brightened images 116 on the display 100x. Under dark conditions while the pupils of the driver 98 are wide, the electronic control unit 94 decreases the overall brightness of the display 100x (e.g., decreases the background light source) to keep the images 116 on the display 100x from becoming a distraction. Lowering the background light source of each zone independently as a function of the “on” pixel percentage in each zone in the display 100x under dim lighting conditions may aid in hiding halo effects around and/or neighboring symbols in the images 116.

FIG. 3 illustrates a perspective schematic diagram of an example implementation of the display 100x in accordance with one or more exemplary embodiments. The display 100x generally includes a backlight source 140 that generates a background light 150, and a transmissive display 160 that passes and/or blocks the background light 150 through an array of pixels to produce the images 116.

The backlight source 140 defines a full area matrix with multiple backlight zones 142a-142n. The backlight source 140 is operational to generate a local background light from each backlight zone 142a-142n (collectively a background light 150) in response to the background signal 114. The local background lights may be controlled independently of each other such that some zones are dark where the display 100x is back, while other zones are dim to bright where the display 100x shows symbols to the driver 98 (FIG. 2). In various embodiments, the backlight zones 142a-142n are implemented as an array of light emitting diodes (LEDs).

The background light 150 implements a matrix of parallel local background lights. The local background lights are controlled to be dark where the display 100x is meant to be dark, and bright where the display 100x is meant to be light. In some embodiments, each backlight zone 142a-142n may include a single or a few LEDs. Therefore, the intensity of the background light 150 may vary across the individual backlight zones 142a-142n. To compensate for the varying intensity, the electronic control unit 94 may activate one or more neighboring backlight zones 142a-142n to establish a more uniform intensity of the background light 150.

The transmissive display 160 may implement a thin-film transistor (TFT) display or a liquid crystal display (LCD). The transmissive display 160 includes an array of pixels 162a-162n. Each pixels 162a-162n is controllable to be in an off state (e.g., no transmission of the background light 150) or in an on-state (e.g., transmission of the background light). The on-state may include multiple levels of “on” ranging from dim (or low transmission) to bright (or full transmission). Corresponding arrays of the pixels 162a-162n (e.g., 2×2 pixels, 4×2 pixels, 4×4 pixels, 8×4 pixels, 8×8 pixels, etc.) may be spatially aligned with each backlight zone 142a-142n. Therefore, whenever one or more pixels 162a-162n is in the on-state, the corresponding backlight zone 142a-142n, and sometimes one or more neighboring backlight zones 142a-142n, generates the local background light. A combination of the transmission/blockage of the background light 150 by the pixels 162a-162n generates the images 116.

Because the LEDs are generally powered for a portion of the transmissive display 160 that has symbology in the video signal 118, some power savings may be realized if the images 116 have an abundance of black areas that do not utilize the backlighting. In areas that do utilize the backlighting to make the symbols visible, the backlighting amount may be at less than a 100% full “on” level if a gain function (video expansion or video gray shade remapping) is applied to the gray shades thus yielding additional power savings. Unlike organic LED (OLED) displays where on-pixel-ratio (OPR) power calculations are based on power dissipated by each OLED subpixel, the full area local display power calculations are based on the power dissipated by each backlight zone LED.

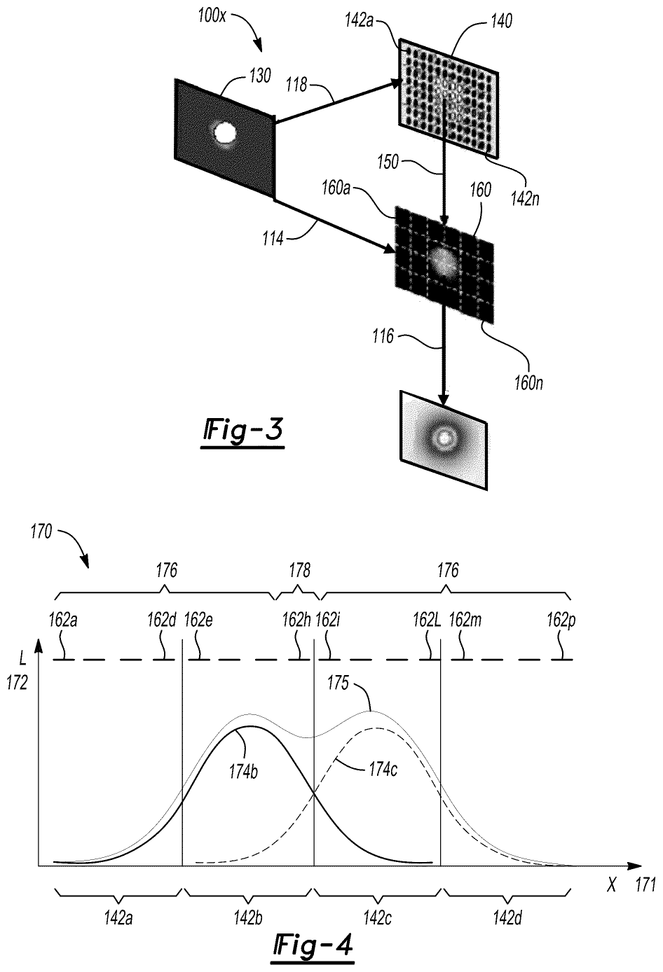

FIG. 4 illustrates a graph 170 of an example light spread function in a single dimension across two backlight zones in accordance with one or more exemplary embodiments. An x-axis 171 of the graph illustrates distance. A y-axis 172 of the graph illustrates luminance.

In the example, a dark first backlight zone (e.g., 142a) does not generate a first luminance curve. A lit second backlight zone (e.g., 142b) generates a second luminance curve 174b with a light spread function (LSF). A lit third backlight zone (e.g., 142c) generates a third luminance curve 174c with a similar light spread function. A dark fourth backlight zone (e.g., 142d) does not generate a fourth luminance curve. A combination of the second luminance curve 174b and the third luminance curve 174c creates a combined luminance curve 175. The combined luminance curve 175 is generally more uniform along the x-axis 171 than the individual luminance curves 174b and 174c. The first backlight zone 142a may be aligned with the pixels 162a-162d. The second backlight zone 142b may be aligned with pixels 162e-162h. The third backlight zone 142c may be aligned with the pixels 162i-162l. The fourth backlight zone 142d may be aligned with the pixels 162m-162p. The various pixels 162a-162p may receive different amounts of backlighting due to the light spread function. For example, the pixel 162e may receive a dimmer backlighting than the pixel 162g.

By way of example, consider a condition where the single pixel 162h is in the on-state (transmissive) and the other pixels 162a-162g and 162i-162p are in the off-state (black). In the black image areas 162a-162g and 162i-162p, a halo 176 (or glow or artifact) may become visible in areas next to the on-state pixel 162h in an illuminated image area because the corresponding backlight zones 142b and 142c may be excited (e.g., lit) to support a symbol 178 in the image 116. Even though the backlight zones 142a and 142d adjacent to the lit backlight zones 142b and 142c may be commanded black due to no video content, the luminance tails in the combined luminance curve 175 from the lit backlight zones 142b and 142c may extend into the adjoining unlit backlight zone 142a and 142d and be seen as the halo 176 due to the leakage through the black (or off) pixels 162a-162g and 162i-162p. In various situations, the tails of the combined curve 175 may extend multiple backlight zones 142a-142n away from each lit backlight zone 142a-142n and in multiple directions.

Most liquid crystal displays have a contrast ratio of about 1000:1 and therefore about 0.1% of the luminance tail behind the black pixels is leaked to the driver 98. The same principle applies to black pixels 162a-162g and 162i-162p within the lit backlight zones 142b-142c where the halo 176 around the symbol 178 is more evident. The halo 176 may be visible because of the higher backlight zone luminance and may be on the order of 1 nit for a display luminance of 1000 nits. Therefore, to make the halo effect less visible in a backlight zone with a small amount of video content (e.g., few on-state pixels), the luminance of the backlight zones may be lowered and the luminance of the gray shades of the image content (if not already at 100%) may be increased. Under high sunlight conditions, the halo effect is not readily noticeable and therefore may be mitigated by increasing the luminance of the background light 150 as a function of the ambient lighting conditions.

FIG. 5 illustrates a graph 180 of an example on-pixel-ratio function 182 (OPRF) in accordance with one or more exemplary embodiments. An x-axis 184 of the graph 180 is generally illustrated as percentages of “on” pixels per backlight zone. A y-axis 186 of the graph 180 is generally illustrated as percentages of relative zone luminance.

With reference back to FIG. 3, an approximately linear line 188 represents the relative backlight zone luminance with the backlight source 140 at a particular luminance. For a small number of fully “on” pixels 162a-162n (e.g., 2.8 percent per backlight zone 142a-142n), the luminance in the lit backlight zones 142a-142n is reduced. In the example, the luminance is reduced to about 50%, although lower levels may be utilized. As the percentage of fully “on” pixels 162a-162n is increased, the luminance in the lit backlight zones 142a-142n is increased towards 100%. In the example, the gray shades in the video signal 118 are unchanged by the on-pixel-ratio function 182 (e.g., because the percentage of full “on” pixels is small).

The idea is to dynamically change the slope of the on-pixel-ratio function 182 as a function of the ambient lighting conditions. For a darkest ambient condition, a slope of the on-pixel-ratio function 182 similar to the line 188 may be employed to reduce the halo visibility. Under a highest ambient lighting condition, the slope of the on-pixel-ratio function 182 may approach or reach zero (e.g., line 190) such that no matter what percentage of the backlight zone pixels are driven, a 100% background luminance is achieved. As illustrated in the example, as the ambient luminance level increases, the relative zone luminance value of approximately 50% would be raised per the arrow 192 to approximately 100%.

From a visibility analysis aspect, under an ambient viewing condition of 600 lux (e.g., normal room ambient condition) and an effective display reflectance of 0.038 nits/lux, a background luminance (BGL) reflected from the display 100x may be determined from equation 1 as follows:

$$BGL = 0.038 \times 600 = 22.8 nits \qquad Eq . ( 1 )$$

Converting to imperial foot-lambert units (fL) is accomplished per equation 2 as follows:

$$BGL = 22.8 nits / 3.42 = 6.66 fL \qquad Eq . ( 2 )$$

In a similar fashion, under high ambient illumination, an example 387 nits of luminance may be reflected. Equation 3 converts the 387 nits to imperial fL units:

$$BGL = 387 nits / 3.42 = 113 fL \qquad Eq . ( 3 )$$

Assuming a 1000 nit display 100x operating at a 50% luminance for halo mitigation, the conversion to imperial units is shown in equations 4 and 5 for display emitted symbol luminance (ESL) as follows:

$$ESL = 1000 nits / 3.42 = 292 fL \qquad Eq . ( 4 )$$

$$ESL = 500 nits / 3.42 = 146 fL \qquad Eq . ( 5 )$$

From these conversions, a table of example high and low reflected background luminance may be realized as follows:

TABLE 1

| Background | % Symbol | Halo Luminance | Symbol Luminance |
|---|---|---|---|
| Luminance (fL) | Luminance | (fL) | (fL) |
| 6.66 | 50% | 0.146 | 146 |
| 6.66 | 100% | 0.29 | 292 |
| 113 | 50% | 0.146 | 146 |
| 113 | 100% | 0.29 | 292 |

FIG. 6 illustrates an example overlay of the reflected background luminance values in Table I on a Burnette visibility analysis graph 200 in accordance with one or more exemplary embodiments. An x-axis 202 of the graph 200 represents a display background luminance in units of foot-lamberts (fL). A y-axis 204 of the graph represents a symbol emitted luminance in units of foot-lamberts. The Burnette visibility analysis may be found in Burnette, K. T., “The Status of Human Perceptual Characteristics Data for Electronic Flight Display Design”, Proceedings of AGARD Conference No. 96 on Guidance and Control Displays, Paris, France, 1972.

For low lighting conditions (line 206), the reduction in halo luminance from 0.29 fL (point 207a) to 0.146 fL (point 207b) generally decreases the luminance below a threshold (e.g., a 50% threshold) visibility line 210 thereby making the halo 176 more difficult to notice, whereas a reduction of the 50% symbol luminance from 292 fL (point 209a) to 146 fL (point 209b) is well above a numeric comfort line 212. However, if the 50% luminance is increased to 100% (as shown by the arrows 214 and 216) under high reflected ambient conditions (line 208), the visibility of the symbol is greatly increased (top arrow 216), while the visibility of the halo is even less visible (bottom arrow 214) than under low lighting conditions 206 and therefore an improvement for both aspects is realized with the concept. A relationship between the display luminance and the reflected background luminance is generally a straight line on the log-log graph 200.

FIG. 7 illustrates a functional block diagram of an example automatic display luminance system 220 in accordance with one or more exemplary embodiments. The system 220 is operational to adjust the display luminance as a function of the reflected background luminance. The adjustment operation is generally described in a paper published by Dr. Louis Silverstein and Robin Hoerner, “The Development and Evaluation of Color Systems for Airborne Applications-Phase I: Fundamental Visual Perceptual, and Display Systems Considerations.” The system 220 is redrawn for clarity and adapted with loop arrows. Silverstein developed the automatic display luminance for global luminance control. In contrast, the display system 91 controls the zone relative luminance line slope. Therefore, some zones that have a large number of “on” pixels generally see little change in luminance, whereas zones that have a small percentage of “on” pixels may see a dramatic increase in pixel luminance. The acronyms used in the figure are:
PWI=peak white intensity;
WSI=white stroke intensity;
FFVI=forward field of view intensity;
TC=time constant; and
EXP=exponential function.

The system 220 establishes how much display luminance is appropriate as a function of the reflected ambient light 124, which is proportional to the illumination level measured by the ambient light sensor 108 located near or on the front of the display 100x. As discussed by Silverstein et al., a relationship between observer-selected emitted symbol luminance (ESL) and the display background luminance (DBL) is a mathematical fractional power function per equation 6 as follows:

$$ESL = {{B}_{O} ( DBL )}^{C} \qquad Eq . ( 6 )$$

Where ESL=Emitted Symbol Luminance in candela per square meter (cd/m²);
B_{O}=Luminance Offset Constant;
DBL=Display Background Luminance in cd/m²; and
C=Power Constant (e.g., the slope of the luminance power function in logarithmic coordinates)

In SI units of cd/m², the Silverstein curve has a B_{O}=55.33 and a slope of C=0.273. However, the offset and the slope constants generally remain as variables to “tune” the transfer curve for the specific application, in particular when the forward looking light sensor 104 is not implemented. If only the ambient light sensor 108 is implemented, the offset constant is generally increased to account for a user adaptation mismatch.

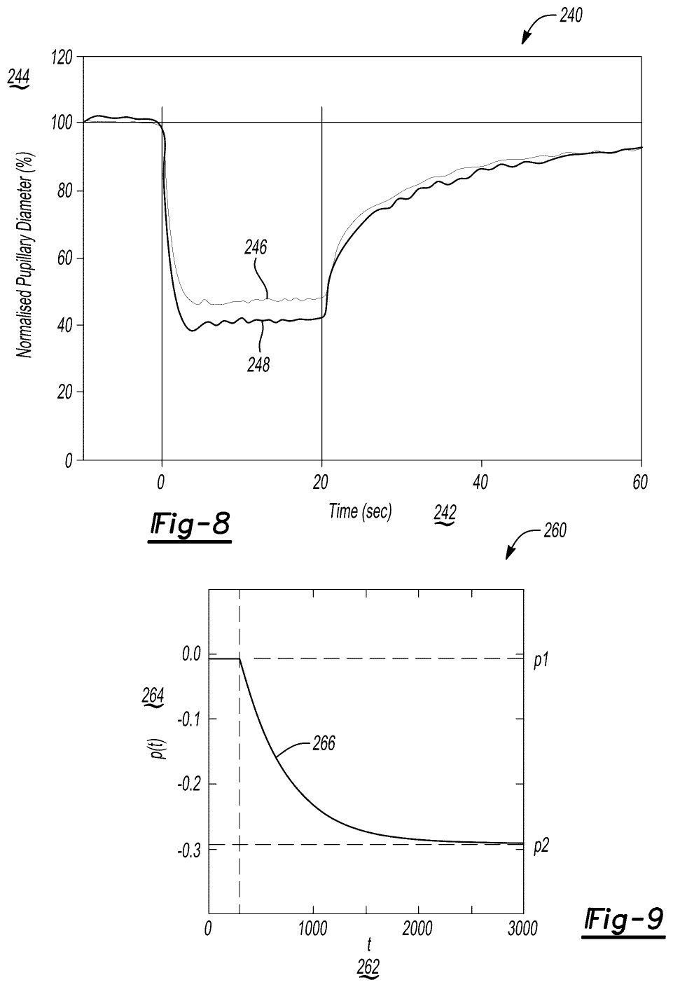

FIG. 8 illustrates a graph 240 of an example pupillary light reflex to a blue light stimulus in accordance with one or more exemplary embodiments. An x-axis 242 of the graph 240 is illustrated in units of second. A y-axis 244 of the graph 240 is illustrated in units of a percentage of normalized pupillary diameter.

The light sensors in the system 220 (FIG. 7) go through a filter with a rise time of approximately 1 second and a fall time of approximately 60 seconds. Note that the response times are approximately exponential in nature and the response to a dimmer condition is slower than to a brighter condition. For a bright luminance pulse of approximately 20 seconds, a line 246 illustrates a control response and a line 248 illustrates an autosomal dominant optic atrophy response.

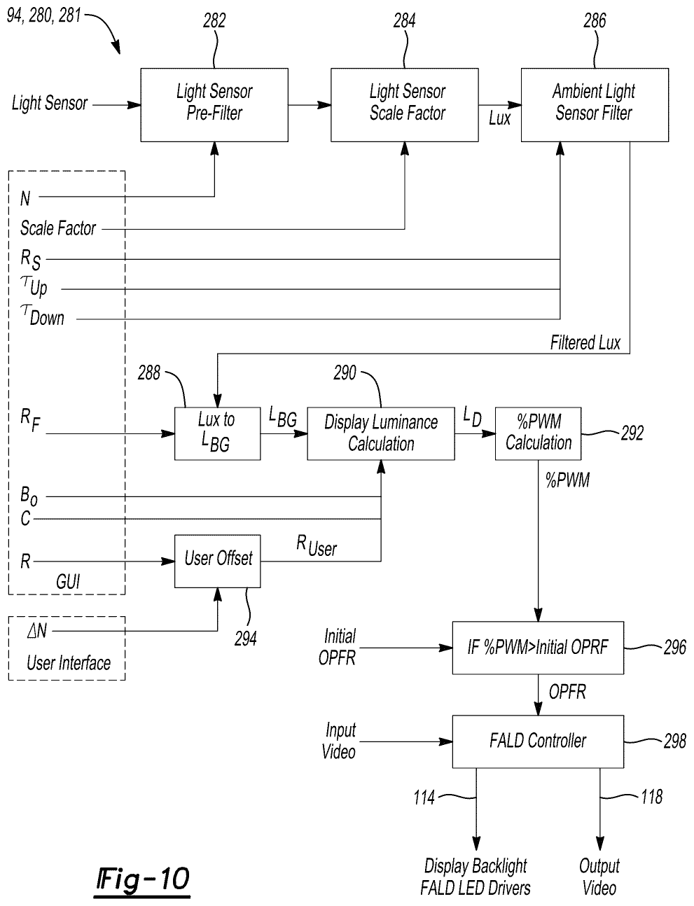

FIG. 9 illustrates a graph 260 of an example pupil diameter response time mode in accordance with one or more exemplary embodiments. An x-axis 262 of the graph 260 illustrates time in units of seconds. A y-axis 264 of the graph 260 illustrates a probability of Land-on-Bright and Land-on-Dark trials. The graph 260 is described in a paper by Sebastiaan Mathot et al., “The Pupillary Light Response Reflects Eye-movement Preparation”, Aix-Marseille University, Marseille, France. In the graph 260, the parameter p₁ is an initial pupil-size difference and p₂ is a final pupil-size difference. A pupil size p(t) is illustrated as a curve 266. Where time (t)≥t₀, p(t) is expressed by equation 7 as follows:

$$p ( t ) = {e}^{\frac{- t + {t}_{0}}{s}} \times ( {p}_{1} - {p}_{2} ) + {p}_{2} \qquad Eq . ( 7 )$$

Where the parameter s is a response speed. Where t<t₀, p(t) is expressed by equation 8 as follows:

$$p ( t ) = {p}_{1} \qquad Eq . ( 8 )$$

A mathematical method to predict a steady state pupil diameter from a dynamic pupillary response assumes that the response is approximately exponential in nature per equation 9 as follows:

$$D = ( {D}_{I} - {D}_{F} ) {e}^{- t / τ} + {D}_{F} \qquad Eq . ( 9 )$$

Where:
D=Pupil Diameter;
D_{I}=Initial Pupil Diameter;
D_{F}=Final Pupil Diameter (steady state); and
τ=Response Time Constant.

Per FIG. 9, the fall and rise time constants are approximately:
T_{Fall}≈1 second; and
T_{Rise}≈10 seconds.

Therefore, using the Silverstein time constants of 1 and 60 seconds may be reasonable. In various embodiments, using the longer 60 second time constant may be implemented since the display may be slightly brighter than desired, which is an acceptable condition. Also, the use of a 60 second fall time constant generally helps a peak detector function to minimize the display variation during a picket fence event. To implement an exponential filter function in software, equation 10 may be utilized:

$$L = \frac{{L}_{New} + ( tc \times R - 1 ) {L}_{Old}}{tc \times R} \qquad Eq . ( 10 )$$

Where R=samples/second.

To deal with different rise and fall time constants, the time constant the is selected based on an “IF” statement per equation 11 as follows:

$${t}_{c} = IF ( {L}_{New} \geq {L}_{Old} , {τ}_{Rise} , {τ}_{Fall} ) \qquad Eq . ( 11 )$$

Since the ambient light sensor 108 may measure illuminance (Lux) from all directions, a conversion factor may be implemented to convert the measured Lux value into the effective reflected background luminance that the driver 98 sees on the display 100x. If an outer-most surface of the display 100x is a smooth shiny anti-reflective surface, the reflected background luminance generally comes from a mirror angle of the user's sight of view angle to the display 100x. So even though the ambient light sensor 108 is measuring illuminance from all angles, the driver 98 see reflections solely from particular angles and therefore the reflected background may be an estimation of the background luminance that the driver 98 is actually seeing. The reflected background luminance from the display 100x, as seen by the driver 98, is generally the reflection of the driver's clothing, bike mechanicals, horizon sky, the road, and the like.

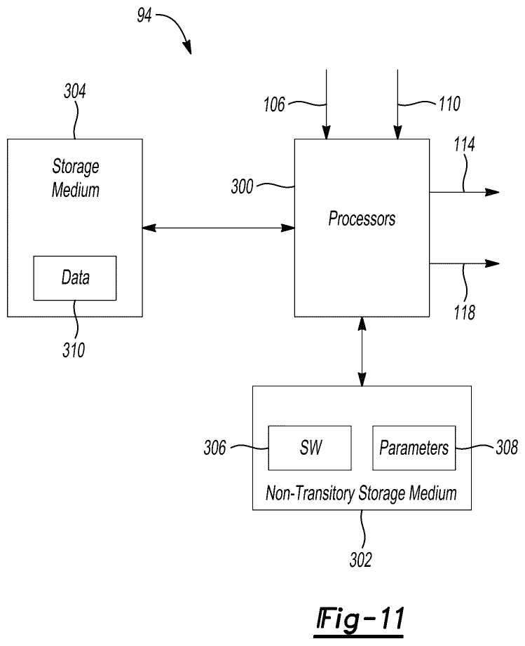

FIG. 10 illustrates a functional block diagram 280 for an example halo mitigation in accordance with one or more exemplary embodiments. The functional block diagram 280 generally includes blocks 282 to 298, as illustrated. The functional block diagram 280 may be implemented in the electronic control unit 94 to perform a video brightness function 281.

With reference back to FIG. 2, the block 282 implements a light sensor pre-filter. The pre-filter is operational to calculate a running average of N samples from the ambient light sensor 108. The running average may be Lux_{New}=Average (N Samples).

The block 284 implements a light sensor scale factor. The scale factor corrects if, for instance, a neutral density filter is present in front of the ambient light sensor 108 to hide an appearance of the ambient light sensor 108. The block 284 presents a scaled luminance (Lux) to the block 286.

The block 286 implements an ambient light sensor filter for eye response time. The filter may be expressed by equation 12 as follows:

$$IF {L}_{XNew} \geq {L}_{XOld} , {t}_{c} = {τ}_{Up} . \qquad Eq . ( 12 )$$

$$IF {L}_{XNew} < {L}_{XOld} , {t}_{c} = {τ}_{Down}$$

$${L}_{X} = \frac{{L}_{XNew} + ( {t}_{c} \times {R}_{s} - 1 ) {L}_{XOld}}{{t}_{c} \times {R}_{S}}$$

The block 286 presents the filtered luminance to the block 288.

The block 288 implements an effective reflectance luminance to reflected background luminance calculation. The block 288 is operational to convert the measured lux level to the reflected background luminance (L_{BG}) seen by the user by using the effective reflectance factor (RF). The reflected background luminance is presented to the block 290.

The block 290 implements a display luminance calculation. The block 290 is operational to calculate an intended display luminance (L_{D}) for visibility. The display luminance may be calculated per equation 13 as follows:

$${L}_{D} = {R}_{User} {{B}_{0} ( {L}_{BG} )}^{C} \qquad Eq . ( 13 )$$

Where R_{User} is a user preference ratio from the block 294. The intended display luminance L_{D} is presented to the block 292.

The block 292 implements a pulse width modulation (PWM) calculation. The block 292 is operational to determine a % PWM of each local backlight based on the display luminance L_{D} received from the block 290 and a maximum display luminance (L_{DMax}) capacity of the backlight source 140 per equation 14 as follows:

$$\% PWM = 100 \frac{{L}_{D}}{{L}_{DMax}} \qquad Eq . ( 14 )$$

The block 294 implements a user offset input function. The user offset input function may be used by the driver 98 to set the user preference R_{User}. as a function parameters R and ΔN, as expressed by equation 15 as follows:

$${R}_{User} \cdot = {R}^{Δ N} \qquad Eq . ( 15 )$$

The driver 98 may set the preference by using a touch screen or other input device within the vehicle 90. The number of preference luminance ratios is determined by the parameter ΔN entered by the driver 98.

The block 296 implements an OPRF determination function. The block 296 is operational to determine if the OPRF (OPR Factor) may be increased to support the visibility criteria. If a suitable % PWM for visibility exceeds the initial OPRF setting, a message is sent to the block 298 to increase the OPRF to the luminance level suitable for symbol visibility. An example of going from an OPRF of 50% to 80% is depicted in FIG. 5.

The block 298 implements a full area local dimming (FALD) controller. The block 298 is operational to depict the various FALD controllers that are presently available. Input video generated internal to the electronic control unit 94 may be received at the block 298. The background signal 114 and the video signal 118 may be presented by the block 298 to the display 100x.

The block 298 is operational to implement the video brightness function 281 (FIG. 10) that affects the video gray shade values in the input video to maintain the desired luminance in a backlight zone depending on the luminance level behind each pixel. The block 298 also receives the desired OPRF from block 296 and modifies the OPRF dynamically to support the visibility criteria.

FIG. 11 illustrates a schematic diagram of an example implementation of the electronic control unit 94 in accordance with one or more exemplary embodiments. The electronic control unit 94 may include one or more processors 300, a non-transitory storage medium 302, and another storage medium 304. The processors 300 may communicate with the forward looking light sensor 104, the ambient light sensor 108 and the displays 100a-100c (FIG. 1) and 100x (FIG. 2).

The non-transitory storage medium 302 may hold one or more instructions 306 (or software programs) executed by the processors 300 to perform the video brightness function and the on-pixel-ratio function for the halo mitigation operations. Preset parameters and user-defined parameters 308 may also be stored in the non-transitory storage medium 302. Volatile data 310 created and/or consumed by the processors 300 may be stored in the storage medium 304.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A display system comprising:
a backlight source that defines a full area matrix of a plurality of backlight zones, and operational to generate a background light in response to a background signal;
a transmissive display with a plurality of pixels, mounted adjacent to the backlight source, and operational to generate a plurality of visible images by modulating the background light in response to a video signal; and
an electronic control unit coupled to the backlight source and the transmissive display, and operational to adjust an on-pixel-ratio function that controls the background signal in response to an ambient light level present at the transmissive display, wherein:
a given zone of the plurality of backlight zones is spatially aligned with at least four of the plurality of pixels of the transmissive display;
the on-pixel-ratio function dynamically darkens the background light on an individual background zone basis in response to the ambient light level and a percentage of the plurality of pixels in the given zone being on pixels to reduce a leakage halo effect; and
the on-pixel-ratio function establishes an approximately linear line from approximately 1 percent of the plurality of pixels in the given zone being on to transmit the background light to approximately 100 percent of the plurality of pixels in the given zone being on to transmit the background light.

2. (canceled)

3. (canceled)

4. The display system according to claim 1, wherein:
a slope of the approximately linear line is (i) a function of the percent of the on pixels, (ii) varies with the ambient light level and (iii) approaches zero as the ambient light level increases.

5. The display system according to claim 1, wherein:
the electronic control unit is further operational to stop the dynamic darkening of the background light at approximately 10 percent of a maximum operational daytime luminance or nighttime luminance.

6. The display system according to claim 1, further comprising:
one or more ambient light sensors operational to sense the ambient light level received along a first direction substantially toward a driver-facing side of the transmissive display, wherein,
the transmissive display presents the plurality of visible images in a second direction away from the transmissive display.

7. The display system according to claim 6, wherein:
the one or more ambient light sensors are one or more instrument panel daylight sensors of a vehicle.

8. The display system according to claim 6, further comprising:
a forward looking light sensor operational to sense a forward light level received substantially along the second direction, wherein:
the electronic control unit is further operational to adjust the on-pixel-ratio function and a video brightness function in response to the forward light level.

9. The display system according to claim 8, wherein:
the forward looking light sensor directly measures the forward light level entering through a front windshield of a vehicle.

10. A method for dynamic halo reduction comprising:
generating a background light in response to a background signal using a backlight source that defines a full area matrix of a plurality of backlight zones;
generating a plurality of visible images by modulating the background light in response to a video signal using a transmissive display with a plurality of pixels and mounted adjacent to the backlight source; and
adjusting an on-pixel-ratio function in an electronic control unit that controls the background signal in response to an ambient light level present at the transmissive display, wherein:
a given zone of the plurality of backlight zones is spatially aligned with at least four of the plurality of pixels of the transmissive display;
the on-pixel-ratio function dynamically darkens the background light on an individual background zone basis in response to the ambient light level and a percentage of the plurality of pixels in the given zone being on pixels to reduce a leakage halo effect; and
the on-pixel-ratio function establishes an approximately linear line from approximately 1 percent of the plurality of pixels in the given zone being on to transmit the background light to approximately 100 percent of the plurality of pixels in the given zone being on to transmit the background light.

11. (canceled)

12. (canceled)

13. The method according to claim 10, wherein:
a slope of the approximately linear line is (i) a function of the percent of the on pixels, (ii) varies and (iii) approaches zero as the ambient light level increases.

14. The method according to claim 10, further comprising:
stopping the dynamic darkening of the background light at approximately 10 percent of a maximum operational daytime luminance or a nighttime luminance.

15. The method according to claim 10, further comprising:
sensing the ambient light level received along a first direction substantially toward a driver-facing side of the transmissive display with one or more ambient light sensors, wherein,
the transmissive display presents the plurality of visible images in a second direction away from the transmissive display.

16. The method according to claim 15, wherein:
the one or more ambient light sensors are one or more instrument panel daylight sensors of a vehicle.

17. The method according to claim 15, further comprising:
sensing a forward light level received substantially along the second direction with a forward looking light sensor; and
the adjusting of the on-pixel-ratio function and a video brightness function are in further response to the forward light level.

18. The method according to claim 17, further comprising:
directly measuring the forward light level entering through a front windshield of a vehicle with the forward looking light sensor.

19. A non-transitory computer readable medium on which is recorded instructions, executable by a processor, for control of a display, wherein execution of the instructions causes the processor to:
generate a background signal that controls a background light in response to a background signal, wherein the background light is generated using a backlight source that defines a full area matrix of a plurality of backlight zones;
generate a video signal that controls a plurality of visible images by modulating the background light in response to a video signal, wherein the plurality of visible images are generated using a transmissive display with a plurality of pixels and mounted adjacent to the backlight source; and
adjust an on-pixel-ratio function that controls the background signal in response to an ambient light level present at the transmissive display, wherein:
a given zone of the plurality of backlight zones is spatially aligned with at least four of the plurality of pixels of the transmissive display;
the on-pixel-ratio function dynamically darkens the background light on an individual background zone basis in response to the ambient light level and a percentage of the plurality of pixels in the given zone being on pixels to reduce a leakage halo effect; and
the on-pixel-ratio function establishes an approximately linear line from approximately 1 percent of the plurality of pixels in the given zone being on to transmit the background light to approximately 100 percent of the plurality of pixels in the given zone being on to transmit the background light.

20. The non-transitory computer readable medium according to claim 19, wherein the processor is further operational to:
stop the dynamic darkening of the background light at approximately 10 percent of a maximum operational daylight luminance or a nighttime luminance.

21. The non-transitory computer readable medium according to claim 19, wherein:
a slope of the approximately linear line is (i) a function of the percent of the on pixels, (ii) varies with the ambient light level and (iii) approaches zero as the ambient light level increases.

22. The non-transitory computer readable medium according to claim 19, wherein the processor:
receives the ambient light level from one or more ambient light sensors sensed along a first direction substantially toward a driver-facing side of the transmissive display, wherein,
the transmissive display presents the plurality of visible images in a second direction away from the transmissive display.

23. The non-transitory computer readable medium according to claim 22, wherein:
the one or more ambient light sensors are one or more instrument panel daylight sensors of a vehicle.

24. The non-transitory computer readable medium according to claim 23, wherein the processor:
receives a forward light level from a forward looking light sensor sensed substantially along the second direction; and
adjusts the on-pixel-ratio function and a video brightness function in response to the forward light level.
